(19) United States
(12) Patent Application Publication
(10) Pub. No.: US 2006/0265393 A1
(43) Pub. Date: Nov. 23, 2006

(54) System and method for implementing workflow in groupware

(76) Inventors: Shai E. Agassi, Los Gatos, CA (US); Frederic E. Samson, Wayne, PA (US); Dirk Wodtke, Aptos, CA (US); Nir Kol, Sunnyvale, CA (US); Iryna Vogler-Ivashchanka, Los Altos, CA (US); Dennis Brian Moore, Hillsborough, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/312,435

(22) Filed: Dec. 21, 2005

Related U.S. Application Data
(60) Provisional application No. 60/650,516, filed on Feb. 8, 2005.

(51) Int. Cl. G06F 17/30

(52) U.S. Cl. 707/10

(57) ABSTRACT

A system and method for implementing workflow in groupware. According to an embodiment of the invention, a groupware application receives one or more communications over a network from a business process server, the one or more communications associated with one or more work items to be performed by a user via the groupware application, the one or more work items associated with a phase of a workflow managed by the business process server, the groupware application receives one or more other communications over the network from the business process server, the one or more other communications including status information associated with one or more other phases of the workflow managed by the business process, and the groupware application provides the status information to the user within the context of the one or more work items to be performed by the user via the groupware application.

### CROSS-REFERENCE TO RELATED APPLICATIONS

This application claims the benefit under 35 U.S.C. § 119(e) of U.S. Provisional Application No. 60/650,516, filed Feb. 8, 2005. U.S. Provisional Application No. 60/650,516 is hereby incorporated by reference, as if repeated herein in its entirety.

### BACKGROUND OF THE INVENTION

The term workflow generally relates to the flow of structured and/or ad-hoc tasks associated with a business process, usually involving an organizational role and people as well as business documents. A computer-supported business workflow allows one to model, execute and control workflows, typically through a graphical user interface (“GUI”).

In current enterprise systems, the human interface to business workflow (i.e., a user reviewing and responding to a task) increasingly involves the use of multiple unrelated desktop applications. For example, a user may receive via a groupware application (i.e., collaborative software, such as a desktop e-mail application) e-mail notifications to complete several business tasks, and then need to launch a Web browser to log on to an enterprise system Web portal to complete the tasks. Not only does the use of multiple unrelated applications in a workflow context increase process completion time, it also exposes the process to higher risk since groupware applications are not engineered with the requisite security and access control mechanisms employed by enterprise systems.

Accordingly, there is a need in the art to implement business process workflow in a way that combines the convenience and usability of groupware applications with the security and robustness of enterprise systems.

### BRIEF DESCRIPTION OF THE DRAWINGS

FIG. 1 is a block diagram that depicts a communication flow between a groupware application and business process server in accordance with an embodiment of the present invention.

FIG. 2 is a block diagram that depicts an architecture implementing a workflow in accordance with an embodiment of the present invention.

FIG. 3 is a screenshot that depicts a workflow step implemented in a groupware application in accordance with an embodiment of the present invention.

FIG. 4 is a block diagram that depicts a computing device in accordance with an embodiment of the present invention.

### DETAILED DESCRIPTION

Embodiments of the present invention extend the reach of the business process directly to the groupware application (e.g., a desktop e-mail or spreadsheet application) and provide contextual information needed to make better informed decisions, allowing users to have a simple yet powerful way to interact with a back-end business process (initiate, react, track, set preferences, etc). Users' input is therefore better and faster due to an actionable interface, contextual information, system awareness (e.g.—who I am in the org chart, etc.), as well as offline capabilities and the power of groupware productivity tools (spell checking, translations and other familiar tools).

Unlike simple e-mail notifications and other current uses of groupware application functionality which focus only on discrete tasks or transactions, embodiments of the present invention instead focus on the business process workflow as a whole by persisting the process information, so that users at any given time can see the latest process status, as well as identify any current bottlenecks and track process activities. Further embodiments of the present invention may include an extended set of filtering tools, reminders and visual hints that allow users to focus even more on the important information that they receive in their inbox.

Users therefore become empowered to make better informed decisions with contextual information (e.g., reports, documents, hints and data from additional relevant fields from back-end business applications, such as SAP ERP, etc.) and can act on them locally within the groupware application. Users also benefit from the familiarity with and integrated use of groupware productivity suite tools, and may be guided with a simple process flow diagram so that they are aware of the previous and next steps in the process and act accordingly.

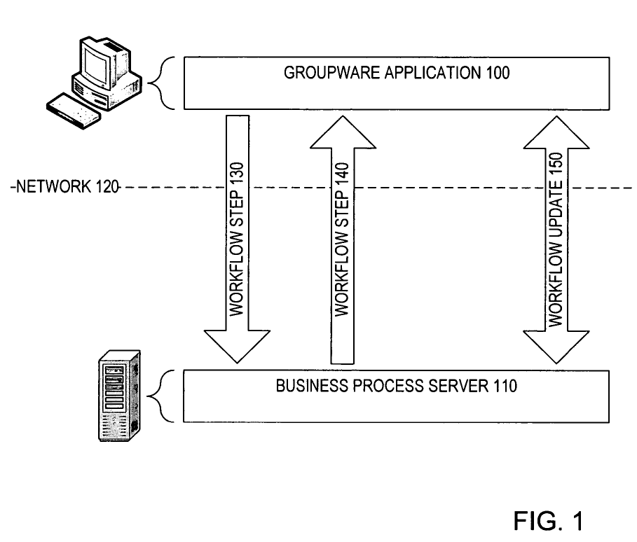

FIG. 1 depicts two types of communication flows over a network (120) between a groupware application (100) and a business process server (110) in accordance with an embodiment of the present invention. The first type of communication flow relates to requests and/or responses associated with particular workflow steps in which a user performs one or more work items via the groupware application (100). This type of communication flow is represented by arrow 130 for a communication from the groupware application (100) to the business process server (110), and by arrow 140 for a communication from the business process server (110) to the groupware application (100).

Arrow 150 represents a second type of communication flow, which relates to the updating of status information pertaining to work items or phases of the workflow other than those associated with the current activity being performed at groupware application (100). This status information enables groupware application (100) to provide the user with information relating not just to the specific task at hand, but to the business process workflow as a whole.

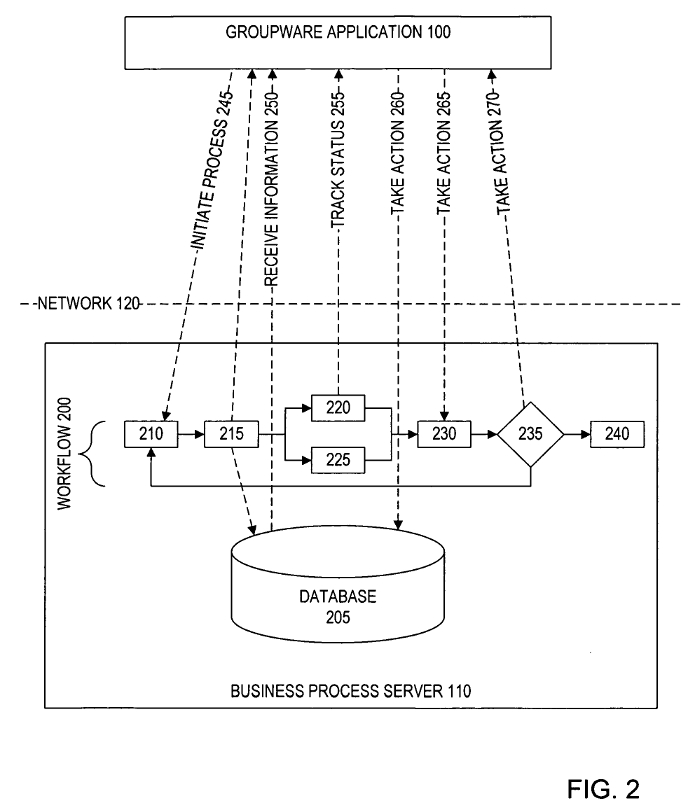

FIG. 2 depicts an architecture implementing a workflow in accordance with an embodiment of the present invention. In this figure, the business process server (110) manages a workflow (200) which comprises various programmed steps or phases (blocks 210, 215, 220, 225, 230, 235 and 240). State information corresponding to the individual phases of the workflow may be persisted in the database (205) and the groupware application (100) (not shown). The dotted lines represent some of the potential communications that can occur between the entities during the workflow process.

For example, a user may trigger the workflow (200) by filling in and executing some type of form or task in the groupware application (100). When the groupware application (100) receives the user's instruction to start the workflow (200), it sends an appropriate message to the business process server (110), as reflected in arrow 245, which starts the workflow (200) as reflected in the first step (210) of the process. The next step of the workflow (215) may involve having someone else perform a work item independent of the groupware application (100), after completion of which the business process server (110) persists the status of the completed work item to its database (205) and the groupware application (100). The remaining steps and communications (250, 255, 260, 265 and 270) may relate to further information sharing, status tracking and other actions being performed in accordance with the workflow (200) managed by the business process server (110).

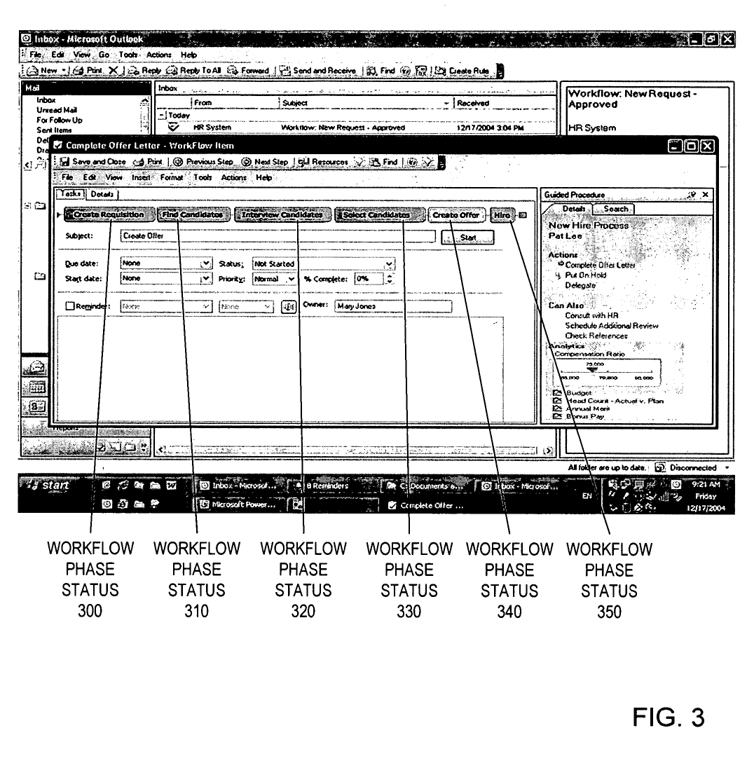

To illustrate by example, FIG. 3 shows a screenshot of a workflow item. labeled “Complete Offer Letter”, which is a work item under a “Create Offer” workflow phase (340) in accordance with an embodiment of the present invention. The workflow item is generated by a desktop e-mail application, and it provides to the user a status of the other phases in a “new hire process” workflow such as “Create Requisition” (300), “Find Candidates” (310), “Interview Candidates” (320), “Select Candidates” (330) and “Hire” (350). In this example, the shading of the workflow phase label can indicate whether the phase is completed or pending.

By providing the status of other phases of the workflow, the user is able to quickly view and understand where the user is in the workflow process, and the user may obtain status information needed or useful to quickly complete the work item at hand by, for example, clicking on any of the buttons representing the other workflow phases. The status information may be persisted at the groupware application (100) for immediate availability to the user, or retrieved from the business process server (110) once requested by the user.

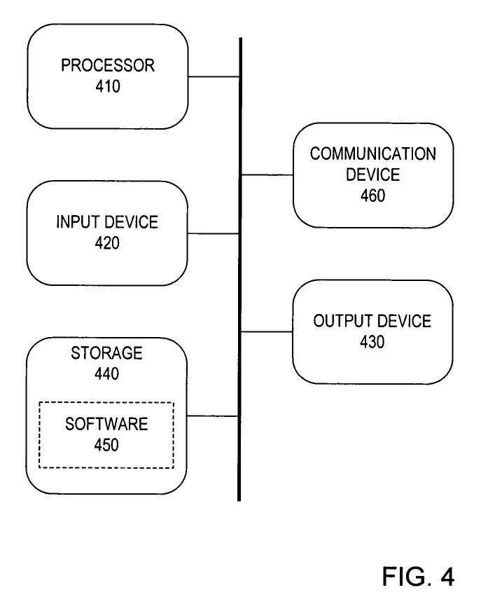

FIG. 4 illustrates the components of a basic computing device in accordance with an embodiment of the present invention, which may include the groupware application (100) and the business process server (110). The computing device may be a personal computer, workstation, handheld personal digital assistant (“PDA”), server, or any other type of microprocessor-based device. The computing device may include one or more of processor 410, input device 420, output device 430, storage 440, and communication device 460.

Input device 420 may include a keyboard, mouse, pen-operated touch screen or monitor, voice-recognition device, or any other device that provides input. Output device 430 may include a monitor, printer, disk drive, speakers, or any other device that provides output.

Storage 440 may include volatile and nonvolatile data storage, including one or more electrical, magnetic or optical memories such as a RAM, cache, hard drive, CD-ROM drive, tape drive or removable storage disk. Communication device 460 may include a modem, network interface card, or any other device capable of transmitting and receiving signals over a network. The components of the computing device may be connected in any manner, such as via electrical bus or wirelessly.

Software 450, which may be stored in storage 440 and executed by processor 410, may include, for example, the application programming that embodies the functionality of the present invention (e.g., as embodied in the groupware application (100) and the business process server (110)). Software 450 may include a combination of client applications and enterprise servers such as an application server and a database server.

Network 120 may include any type of interconnected communication system, which may implement any communications protocol, which may be secured by any security protocol. The corresponding network links may include telephone lines, DSL, cable networks, T1 or T3lines, wireless network connections, or any other arrangement that implements the transmission and reception of network signals.

The computing device may implement any operating system, such as Windows or UNIX. Software 450 may be written in any programming language, such as ABAP, C, C++, lava or Visual Basic. In various embodiments, application software embodying the functionality of the present invention may be deployed on a standalone machine, in a client/server arrangement or through a Web browser as a Web-based application or Web service, for example.

Embodiments of the present invention may extend, using known groupware interfaces, current groupware application objects, forms, data structures and processes with new attributes and capabilities related to a line of business back-end applications. The extension may maintain information in synch or not with the back-end applications, depending on preferences. Embodiments of the present invention may also provide tools to maintain the extensions schema and metadata in synch for ease of deployment and maintenance.

Several embodiments of the invention are specifically illustrated and/or described herein. However, it will be appreciated that modifications and variations of the invention are covered by the above teachings and within the purview of the appended claims without departing from the spirit and intended scope of the invention.

For example, software modules that implement the present invention such as the groupware application (100) and the business process server (110) may comprise several discrete modules that together still provide the same functionality, data specified in the database (205) may be spread over several databases and/or systems, and the communication flows of FIGS. 2 and 3 may encompass combined steps or several intermediate steps that do not detract from the higher level functionality described therein.

Also, the present invention is not limited to a particular workflow such as the “new hire process” described in detail herein, but may include any workflow associated with a computer-supported business process.

What is claimed is:

1. A system for implementing workflow in groupware, comprising:
a groupware application; and
a business process server communicatively linked to the groupware application over a network,
wherein the groupware application receives one or more communications over the network from the business process server, the one or more communications associated with one or more work items to be performed by a user via the groupware application, the one or more work items associated with a phase of a workflow managed by the business process server,
wherein the groupware application receives one or more other communications over the network from the business process server, the one or more other communications including status information associated with one or more other phases of the workflow managed by the business process, and
wherein the groupware application provides the status information to the user within the context of the one or more work items to be performed by the user via the groupware application.

2. The method of claim 1, wherein at least one of the one or more other phases of the workflow is independent of the groupware application.

3. The method of claim 1, wherein the status information is provided to the user via a graphical user interface of the groupware application.

4. The method of claim 1, wherein the groupware application includes an e-mail application.

5. The method of claim 1, wherein the groupware application includes a spreadsheet application.

6. A method for implementing workflow in groupware, comprising:
receiving by a groupware application one or more communications over a network from a business process server, the one or more communications associated with one or more work items to be performed by a user via the groupware application, the one or more work items associated with one or more phases of a workflow managed by the business process server;
receiving by the groupware application one or more other communications over the network from the business process server, the one or more other communications including status information associated with one or more other work items associated with the workflow and independent of the groupware application; and
providing to the user by the groupware application the status information within the context of the one or more work items to be performed by the user via the groupware application.

7. The method of claim 6, wherein at least one of the one or more other work items is associated with one or more other phases of the workflow.

8. The method of claim 6, wherein at least one of the one or more other work items is associated with at least one of the one or more phases of the workflow.

9. The method of claim 6, wherein the status information is provided to the user via a graphical user interface of the groupware application.

10. The method of claim 6, wherein the groupware application includes an e-mail application.

11. The method of claim 6, wherein the groupware application includes a spreadsheet application.

12. A system for implementing workflow in groupware, comprising:
means for receiving by a groupware application one or more communications over a network from a business process server, the one or more communications associated with one or more work items to be performed by a user via the groupware application, the one or more work items associated with one or more phases of a workflow managed by the business process server;
means for receiving by the groupware application one or more other communications over the network from the business process server, the one or more other communications including status information associated with one or more other work items associated with the workflow and independent of the groupware application; and
means for providing to the user by the groupware application the status information within the context of the one or more work items to be performed by the user via the groupware application.
